(19) United States
(12) Patent Application Publication
(10) Pub. No.: US 2014/0123200 A1
(43) Pub. Date: May 1, 2014

(54) DEVICE HOSTING WEB-BASED APPLICATIONS

(71) Applicant: KT Corporation, Seongnam-si (KR)

(72) Inventors: Suho PARK, Seoul (KR); Young-dal KWON, Seoul (KR)

(73) Assignee: KT Corporation, Seongnam-si (KR)

(21) Appl. No.: 14/069,862

(22) Filed: Nov. 1, 2013

(30) Foreign Application Priority Data
Nov. 1, 2012 (KR) 10-2012-0123216

(51) Int. Cl. H04N 21/81; H04N 21/61

(52) U.S. Cl. CPC H04N 21/8173; H04N 21/6175
USPC 725/110

(57) ABSTRACT

In at least one example embodiment, there is a device that displays television content on a display. The device may include a web browser engine configured to host a plurality of web-based applications; at least one web socket configured to provide each of the plurality of web-based applications with at least one respective TCP connection; and a service management unit configured to transmit data packets from at least one of the plurality of web-based applications to an external device via the at least one web socket.

### TECHNICAL FIELD

The embodiments described herein pertain generally to a device that hosts or executes web-based applications.

### BACKGROUND

A television device may enable a user to not only watch television content or video on demand (VOD) but may also execute plural applications.

### SUMMARY

In one example embodiment, there may be a device that displays television content on a display. The device may include a web browser engine configured to host a plurality of web-based applications; at least one web socket configured to provide each of the plurality of web-based applications with at least one respective TCP connection; and a service management unit configured to transmit data packets from at least one of the plurality of web-based applications to an external device via the at least one web socket.

In another example embodiment, a method may include executing a plurality of web-based applications; providing each of the plurality of web-based applications with at least one respective TCP connection; and transmitting data packets from one of the plurality of web-based applications to an external device via the at least one respective TCP connection.

In yet another example embodiment, a computer-readable storage medium having thereon computer-executable instructions that, in response to execution, may cause a device to perform operations including: executing a plurality of web-based applications; providing at least one respective TCP connection to each of the plurality of web-based applications; and transmitting data packets from at least one of the plurality of web-based applications to an external device via the at least one respective TCP connection.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which a device that displays television content may also host web-based applications, in accordance with various embodiments described herein;

FIG. 2 shows an example configuration of a device on which web-based applications may be hosted and executed, in accordance with embodiments described herein;

FIG. 3 shows an example processing flow of operations by which at least portions of service registration may be implemented, in accordance with embodiments described herein;

FIG. 4 shows an example processing flow of at least partial interactions between a service management unit and a remote controller, in accordance with embodiments described herein;

FIG. 5 shows an example processing flow of at least partial interactions between a first web-based application and a second web-based application, in accordance with embodiments described herein;

FIG. 6 shows another example processing flow of at least partial interactions between a web-based application and a server, in accordance with embodiments described herein;

FIG. 7 shows an example processing flow of operations by which an erroneous web-based application may be invoked, in accordance with embodiments described herein; and

FIG. 8 shows an illustrative computing embodiment, in which any of the processes and sub-processes of hosting and executing web-based applications may be implemented as computer-readable instructions stored on a computer-readable medium, in accordance with embodiments described herein.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

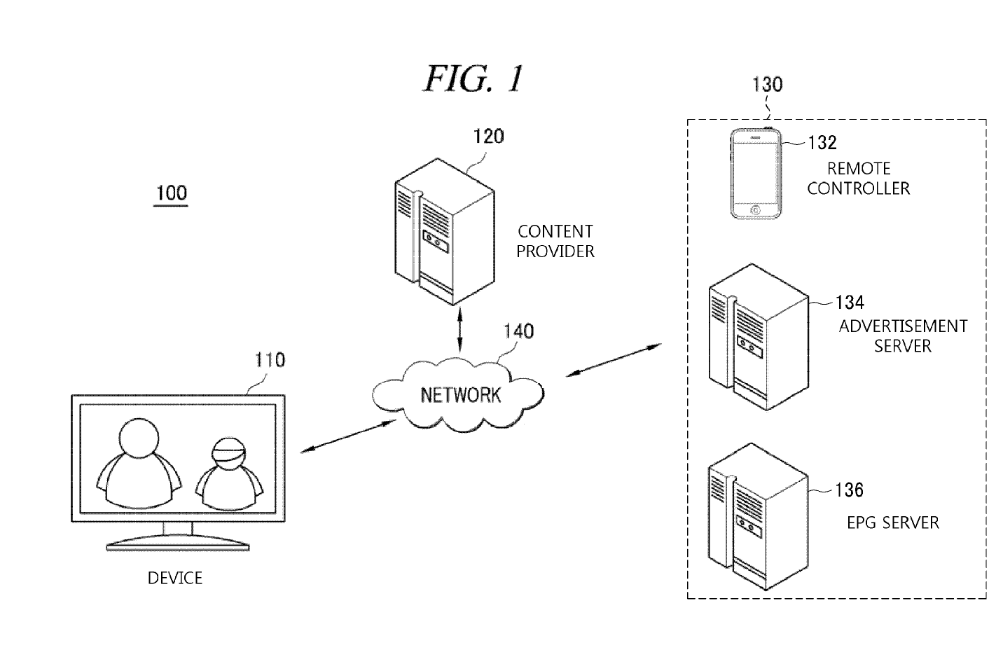

FIG. 1 shows an example system configuration 100 in which a device 110 that displays television content may also host web-based applications, in accordance with various embodiments described herein. As depicted in FIG. 1, system configuration 100 may include, at least, device 110; a content provider 120 that may be representative of one or more servers operated by a content provider; external devices 130 including, for example, a remote controller 132: one or more third-party servers 134, and one or more electronic programming guide (EPG) servers 136. At least two or more of device 110, content provider 120, external devices 130 may be communicatively connected to each other via a network 140.

Device 110 may refer to a display apparatus configured to play various types of media content, such as television content, video on demand (VOD) content, music content, various other media content, etc. Device 110 may further refer to at least one of an IPTV (Internet protocol television), a DTV (digital television), a smart TV, a connected TV or a STB (set-top box), a mobile phone, a smart phone, a tablet computing device, a notebook computer, a personal computer or a personal communication terminal. Non-limiting examples of such display apparatuses may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Further, in accordance with various embodiments described herein, device 110 may be configured to host and/or execute web-based applications. Non-limiting examples of such web-based applications may correspond to a remote controlling service, electronic programming guide (EPG) service, a video-on-demand (VOD) service, an advertisement service, a searching service operated by a search engine, etc. As referenced herein, one of the executed web-based applications may communicatively interact with one or more of external apparatuses 130. In some embodiments, one of the executed web-based applications may communicatively interact with another web-based application executed on device 110.

Content provider 120 may refer to an Internet service provider (ISP); application service provider (ASP); storage service provider (SSP); and television service provider, i.e., cable TV, DSL and DBS, that may be configured to receive a request for television content, video on demand (VOD) content, music content, etc., i.e., requested media content, that may be selected by the user, via device 110, and to further transmit the requested media content to device 110.

External devices 130 may be configured to communicatively interact with the web-based applications hosted and executed on device 110. That is, one or more of external devices 130 may receive a service request from at least one of the executed web-based applications, and the one or more receiving external devices 130 may transmit a service response to the one or more executed web-based applications, and vice versa. In accordance with various embodiments described herein, external devices 130 may include one or more of remote controller 132, one or more third-party servers 134, and one or more EPG servers 136, in various combinations and permutations.

Remote controller 132 as a service client may be configured to transmit, to one of the executed, or executing, or executable web-based applications on device 110, a service request. For example, remote controller 132 may transmit a request to control various aspects of media content play on device 110 including, but not limited to, rewind, fast forward, pause, or stop. Further, remote controller 132 may transmit a request to control various operations of executing or executed web-based application on device 110.

As referenced herein, remote controller 132 may be implemented as a smart phone, and a remote controller application may be hosted and/or executed on the smart phone. The user may download the remote controller application from a virtual application market, non-limiting examples of which may include the Apple™ App Store, the Google™ Google Play, etc.

One or more of third-party servers 134 may be operated by, e.g., one or more advertisement companies. As referenced herein, the advertisement companies may generate plural advertisement content with respect to particular goods or services. Further, one or more third-party servers 134 hereafter may be referred as “advertisement server 134” without limiting such features in terms of quantity, unless context requires otherwise.

Advertisement server 134 may be configured to receive, from one of the executed, or executing, or executable web-based applications, a service request corresponding to a corresponding advertisement service and transmit a service response, as a service host, to one of the executed, or executing, or executable web-based applications. As referenced herein, the advertisement service may be representative of, for example, determining appropriate advertisement content to a user of device 110 and providing the user with the determined advertisement content. That is, when receiving the service request corresponding to the corresponding advertisement service, advertisement server 134 may select advertisement content appropriate to the user from among the plural generated advertisement content by using, for example, a content usage history for the user and/or user's preference. Then, advertisement server 134 may transmit, to the one of the executed, or executing, or executable web-based application, the selected advertisement content as the service request.

A role of advertisement server 134 is not limited to the service host, by way of example, advertisement server 134 may be implemented as a service client that transmits a service request corresponding to the advertisement service to a web-based application executed on device 110. As referenced herein, the service request may represent a request for the content usage history, and/or the user's preference as set forth above.

One or more EPG servers 136 may be operated by one or more telecommunications service providers, and hereafter may be referred as “EPG server 136” without limiting such features in terms of quantity, unless context requires otherwise. Further, EPG server 136 may transmit and receive a service request corresponding to the EPG service as a service host or a service client, similarly to advertisement server 134. As referenced herein, the EPG service may include, for example, a reservation service of media content from among plural media content shown on EPG; a personalization service for generating the user's own EPG based at least in part a content usage history and/or user's preference. Further, the EPG service may include a recommendation service for at least one media content.

Network 140, which may be configured to communicatively couple one or more of device 110, content provider 120 and external device 130, may be implemented in accordance with any wireless network protocol, such as a mobile radio communication network including at least one of a 3rd generation (3G) mobile telecommunications network, a 4th generation (4G) mobile telecommunications network, any other mobile telecommunications networks, WiBro (Wireless Broadband Internet), Mobile WiMAX, HSDPA (High Speed Downlink Packet Access) or the like. Alternatively, network 140 may include at least one of a near field communication (NFC), radio-frequency identification (RFID) or peer to peer (P2P) communication protocol

Thus, FIG. 1 shows an example system configuration 100 in which device 110 that displays television content may also host web-based applications, in accordance with various embodiments described herein.

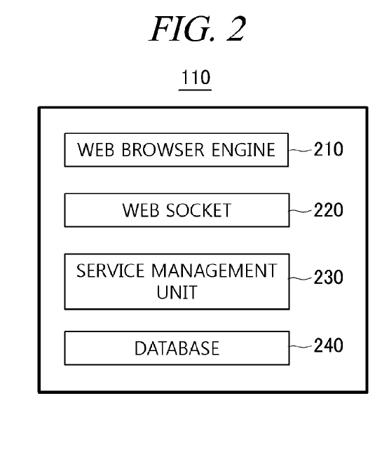

FIG. 2 shows an example configuration 200 of device 110 on which web-based applications may be hosted and executed, in accordance with embodiments described herein. As depicted in FIG. 2, device 110, first described above with regard to FIG. 1, may include a web-browser engine 210, at least one web socket 220, a service management unit 230, and a database 240.

Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of web-browser engine 210, at least one web socket 220, service management unit 230, and database 240 may be included in an instance of an application hosted by device 110.

Web-browser engine 210 may be a component or module that is programmed and/or configured to host and/or execute at least a portion of the total functionality of a plurality of web-based applications. As set forth above, each of the plurality of web-based applications may correspond to, as examples, remote controlling service, EPG service, a VOD service, an advertisement service, a searching service operated by a search engine, etc.

At least one web socket 220 may be a component or module that is programmed and/or configured to be communicatively connected to at least one of the plurality of web-based applications via a transmission control protocol (TCP) connection.

In some embodiments, at least one web socket 220 may be further programmed and/or configured to provide service management unit 230 with at least one respective TCP connection to one or more respective web-based applications. Alternatively, at least one respective TCP connection connecting service management unit 230 with at least one web socket 220 may be provided by service management unit 230.

Service management unit 230 may be a component or module that is programmed and/or configured to be communicatively connected with one or more of external apparatuses 130.

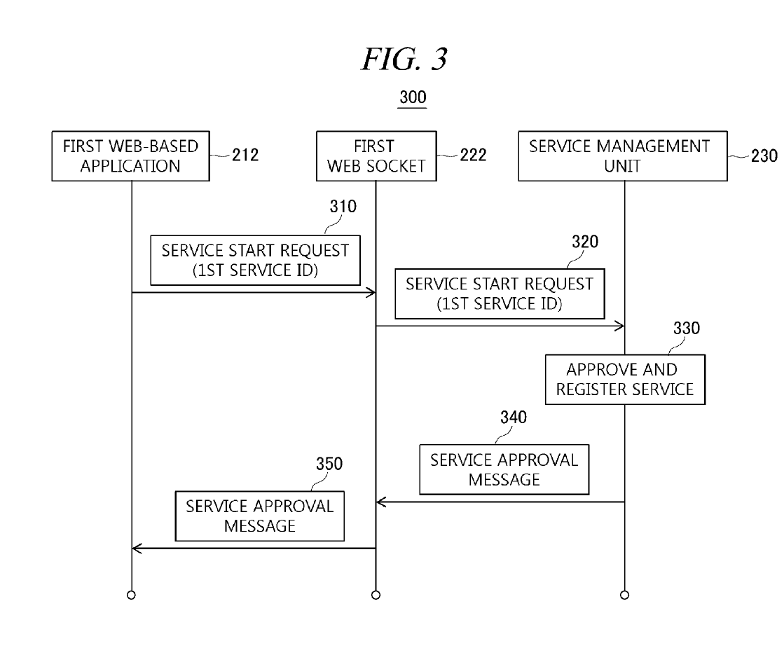

Service management unit 230 may be further programmed and/or configured to receive, from one or more of the aforementioned web-based applications, a request to start a service corresponding to the web-based application when the web-based application is executed by web browser engine 210. Then, service management unit 230 may approve the request to start the service and register a service identifier corresponding to the executed web-based application into an activated service list. Further, service management unit 230 may transmit, to the executed web-based application, a service approval message as depicted and described with reference to FIG. 3.

FIG. 3 shows an example processing flow 300 of operations by which at least portions of service registration may be implemented, in accordance with embodiments described herein. The operations of processing flow 300 may be implemented in system configuration 100 including a first web-based application 212 executed by web browser engine 210; and a first web socket 222 corresponding to first web-based application 212, and service management unit 230 included in device 110 as illustrated in FIG. 1 and FIG. 2. Processing flow 300 may include one or more operations, actions, or functions as illustrated by one or more blocks 310, 320, 330, 340, and/or 350. Although illustrated as discrete blocks, various blocks may be divided into additional blocks, combined into fewer blocks, or eliminated, depending on the desired implementation. Processing may begin at block 310.

Block 310 (Transmit Service Start Request) may refer to first web-based application 212 transmitting, to first web socket 222, a request to start a first service corresponding to first web-based application 212 when web browser engine 210 executes first web-based application 212. As referenced herein, a first service identifier of the first service may be included in the request to start the first service. Processing may proceed from block 310 to block 320.

Block 320 (Transmit Service Start Request) may refer to first web socket 222 transmitting, to service management unit 230, the request to start the first service received from first web-based application 212. Processing may proceed from block 320 to block 330.

Block 330 (Approve and Register Service) may refer to service management unit 230 approving the first service, and register the first service identifier included in the request to start the first service received from first web socket 222 into an activated service list. If there is no activated service list in service management unit 230, service management unit 230 may generate the activated service list to register the first service identifier. Processing may proceed from block 330 to block 340.

Block 340 (Transmit Service Approval Message) may refer to service management unit 230 transmitting, to first web socket 222, a service approval message indicating that service management unit 230 approved the first service. Processing may proceed from block 340 to block 350.

Block 350 (Transmit Service Approval Message) may refer to first web socket 222 transmitting, to first web-based application 212, the service approval message received from first web socket 222.

Thus, FIG. 3 shows example processing flow 300 of operations by which at least portions of service registration may be implemented, in accordance with embodiments described herein.

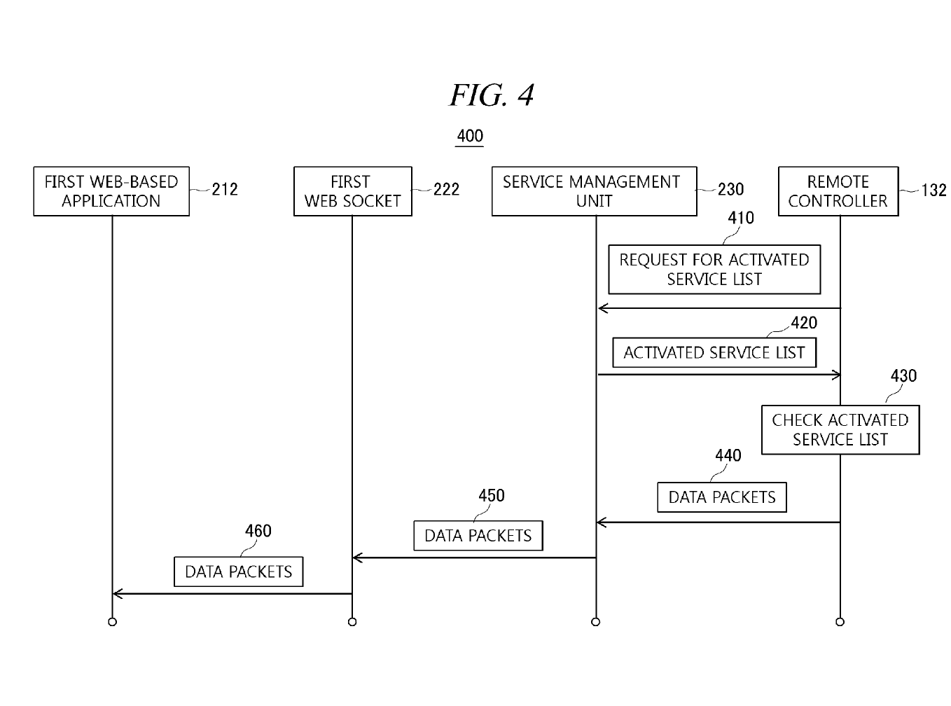

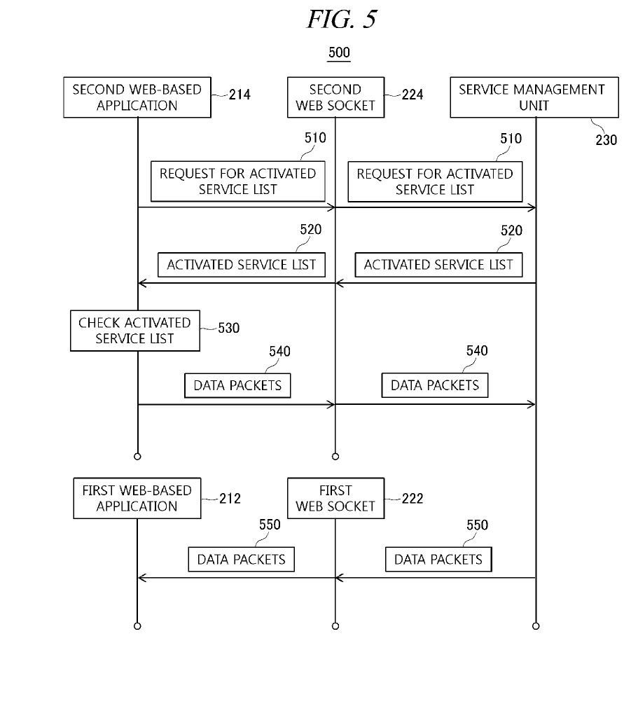

Referring again to FIG. 2, service management unit 230 may be further programmed and/or configured to transmit, to the executed web-based application, data packets received from external devices 130 or another web-based application based at least in part the activated service list as depicted and described with reference to FIG. 4 and FIG. 5.

FIG. 4 shows an example processing flow 400 of at least partial interactions between service management unit 230 and remote controller 132, in accordance with embodiments described herein. The operations of processing flow 400 may be implemented in system configuration 100 including first web-based application 212 executed by web browser engine 210; and a first web socket 222 corresponding to first web-based application 212, service management unit 230 included in device 110; and remote controller 132 as illustrated in FIG. 1 and FIG. 2.

As referenced herein, first web-based application 212 may refer to a media content play service. When remote controller 132 receives an order for controlling one or more aspects of the media content play on device 110 including, but not limited to, rewind, fast forward, pause, or stop, remote controller 132 may check on whether first web-based application 212 controllable by remote controller 132 is activated. Then, if first web-based application 212 is activated, remote controller 132 may transmit, to first web-based application 212, data packets including a control signal for controlling of various aspects of the media content play.

Processing flow 400 may include one or more operations, actions, or functions as illustrated by one or more blocks 410, 420, 430, 440, 450, and/or 460. Although illustrated as discrete blocks, various blocks may be divided into additional blocks, combined into fewer blocks, or eliminated, depending on the desired implementation. Processing may begin at block 410.

Block 410 (Transmit Request for Activated Service List) may refer to remote controller 132 transmitting, to service management unit 230, a request for activated service list to confirm whether service management unit 230 supports remote controlling service corresponding to both first web-based application 212 and remote controller 132. Processing may proceed from block 410 to block 420.

Block 420 (Transmit Activated Service List) may refer to service management unit 230 transmitting the requested activated service list to remote controller 132. Processing may proceed from block 420 to block 430.

Block 430 (Check Activated Service List) may refer to remote controller 132 checking the received activated service list. For example, remote controller 132 may check whether a service identifier of the remote controlling service is included in the activated service list. Processing may proceed from block 430 to block 440.

Block 440 (Transmit Data Packets) may refer to remote controller 132 transmitting, to service management unit 230, data packets with respect to the remote controlling service. Processing may proceed from block 440 to block 450.

Block 450 (Transmit Data Packets) may refer to service management unit 230 transmitting, to first web socket 222, the received data packets by designating first web-based application 212 as a destination for the transmitting of data packets. Processing may proceed from block 450 to block 460.

Block 460 (Transmit Data Packets) may refer to first web socket 222 transmitting, to first web-based application 212, the received data packets by using the designated destination.

Thus, FIG. 4 shows example processing flow 400 of at least partial interactions between service management unit 230 and remote controller 132, in accordance with embodiments described herein.

FIG. 5 shows an example processing flow 500 of at least partial interactions between a first web-based application 212 and a second web-based application 214, in accordance with embodiments described herein. The operations of processing flow 500 may be implemented in system configuration 100 including first web-based application 212 and second web-based application 214 executed by web browser engine 210; and a first web socket 222 corresponding to first web-based application 212, a second web socket 224 corresponding to second web-based application 214, service management unit 230 included in device 110 as illustrated in FIG. 1 and FIG. 2.

As referenced herein and in accordance with at least one example embodiment, first web-based application 212 may refer to a media content play service, and second web-based application 214 may refer to an online chat service. While media content is played on device 110, the user's account for the online chat service may receive a text message from another user's account. Then, second web-based application 214 may check on whether an interaction between first web-based application 212 and second web-based application 214 is available by using an activated service list. If, the interaction between first web-based application 212 and second web-based application 214 is available, second web-based application 214 may transmit, to first web-based application 212, data packets including the received text message to display the text message on the played media content.

As referenced herein, first web socket 222 may be same as second web socket 224. Further, a first service corresponding to first web-based application 212 and a second service corresponding to second web-based application 214 may be registered in service management unit 230, or each protocol corresponding to the first service and/or second service may be registered in service management unit 230 as a supportable protocol.

Processing flow 500 may include one or more operations, actions, or functions as illustrated by one or more blocks 510, 520, 530, 540, and/or 550. Although illustrated as discrete blocks, various blocks may be divided into additional blocks, combined into fewer blocks, or eliminated, depending on the desired implementation. Processing may begin at block 510.

Block 510 (Transmit Request for Activated Service List) may refer to second web-based application 214 transmitting, to service management unit 230 via second web socket 224, a request for activated service list to confirm whether service management unit 230 supports the first service. Processing may proceed from block 510 to block 520.

Block 520 (Transmit Activated Service List) may refer to service management unit 230 transmitting the requested activated service list to second web-based application 214 via second web socket 224. Processing may proceed from block 520 to block 530.

Block 530 (Check Activated Service List) may refer to second web-based application 214 checking the received activated service list. For example, second web-based application 214 may check whether a service identifier of the first service is included in the received activated service list. Processing may proceed from block 530 to block 540.

Block 540 (Transmit Data Packets) may refer to second web-based application 214 transmitting, to service management unit 230 via second web socket 224, data packets with respect to the first service. Processing may proceed from block 540 to block 550.

Block 550 (Transmit Data Packets) may refer to service management unit 230 transmitting, to first web-based application 212 via first web socket 222, the received data packets by designating first web-based application 212 as a destination for the transmitting of data packets.

Thus, FIG. 5 shows example processing flow 500 of at least partial interactions between first web-based application 212 and second web-based application 214, in accordance with embodiments described herein.

Referring again to FIG. 2, service management unit 230 may be further programmed and/or configured to receive, from one of the plurality of web-based applications, a request to convert a protocol when the one of the plurality of web-based applications requires a protocol conversion to interwork the one of the plurality of web-based applications with one of external devices 130. As referenced herein, the request to convert the protocol may include protocol information requested by the one of the plurality of web-based application.

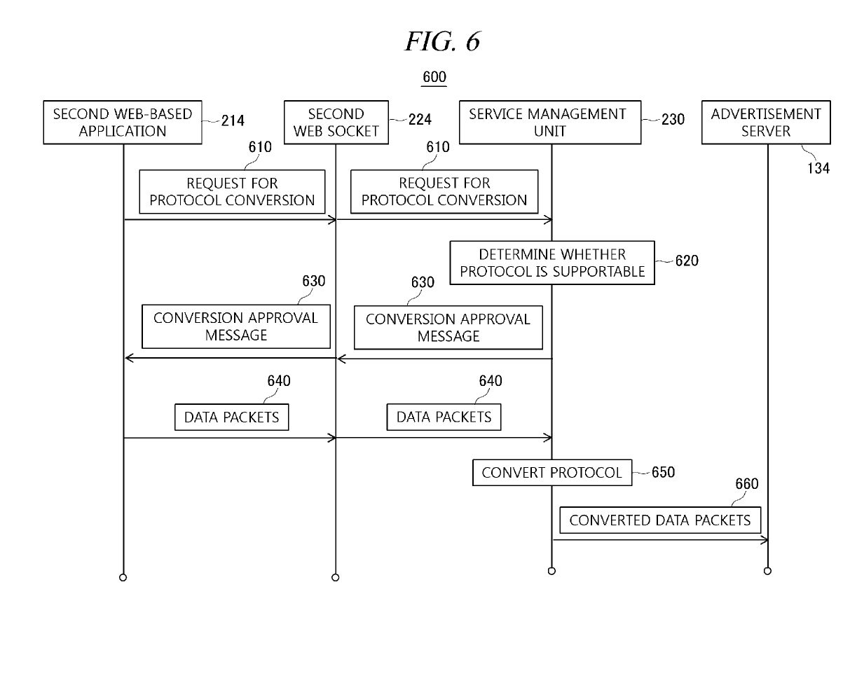

Service management unit 230 may transmit, to the one of the plurality of web-based applications, a conversion approval message if a protocol described in the protocol information is supportable by the service management unit 230. Then, service management unit 230 may receive, from the one of the plurality of web-based applications, first protocol data packets corresponding to the one of the plurality of web-based applications, and convert the first protocol data packets into second protocol data packets corresponding to the one of external devices 130 or another web-based application to transmit the converted second protocol data packets to the one of external devices 130 or the another web-based application as depicted and described with reference to FIG. 6.

FIG. 6 shows another example processing flow 600 of at least partial interactions between a web-based application and a server, in accordance with embodiments described herein. The operations of processing flow 600 may be implemented in system configuration 100 including second web-based application 214 executed by web browser engine 210; and a second web socket 224 corresponding to second web-based application 214, service management unit 230 included in device 110; and advertisement server 134 as illustrated in FIG. 1 and FIG. 2.

As referenced herein and in accordance with at least one example embodiment, second web-based application 214 may refer to an online chat service. During an online chatting, second web-based application 214 may transmit, to advertisement server 134, a request for an advertisement appropriate to the user to be displayed on a display for the online chat service. But, if a protocol for second web-based application 214 is different from a protocol for advertisement server 134, second web-based application 214 may not transmit the request for the advertisement. Thus, in this case, second web-based application 214 may transmit, to service management unit 230, a request for a protocol conversion.

Processing flow 600 may include one or more operations, actions, or functions as illustrated by one or more blocks 610, 620, 630, 640, 650, and/or 660. Although illustrated as discrete blocks, various blocks may be divided into additional blocks, combined into fewer blocks, or eliminated, depending on the desired implementation. Processing may begin at block 610.

Block 610 (Transmit Request for Protocol Conversion) may refer to second web-based application 214 transmitting, to service management unit 230 via second web socket 224, a request for protocol conversion to interwork second web-based application 214 with advertisement server 134 which have different protocol. As referenced herein, the request for protocol conversion may include protocol information corresponding to second web-based application 214. Processing may proceed from block 610 to block 620.

Block 620 (Determine whether Protocol is Supportable) may refer to service management unit 230 determining whether a protocol corresponding to the second web-based application is supportable by service management unit 230 by using the protocol information. Processing may proceed from block 620 to block 630.

Block 630 (Transmit Conversion Approval Message) may refer to service management unit 230 transmitting, to second web-based application 214 via second web socket 224, a notification that the protocol described in the protocol information is supportable by service management unit 230. Processing may proceed from block 630 to block 640.

Block 640 (Transmit Data Packets) may refer to second web-based application 214 transmitting, to service management unit 230 via second web socket 224, data packets in the protocol. Processing may proceed from block 640 to block 650.

Block 650 (Convert Protocol) may refer to service management unit 230 converting the protocol corresponding to the second web-based application into another corresponding to advertisement server 134. Processing may proceed from block 650 to block 660

Block 660 (Transmit Converted Data Packets) may refer to service management unit 230 transmitting, to advertisement server 134, the converted data packets into the another protocol corresponding to advertisement server 134.

Thus, FIG. 6 shows another example processing flow 600 of at least partial interactions between the web-based application and the server, in accordance with embodiments described herein.

External devices 130 illustrated in FIG. 4 and FIG. 6 are not limited to respective remote controller 132 and advertisement server 134. By way of example, another one of external devices 130 may be operated instead of remote controller 132 and/or advertisement server 134.

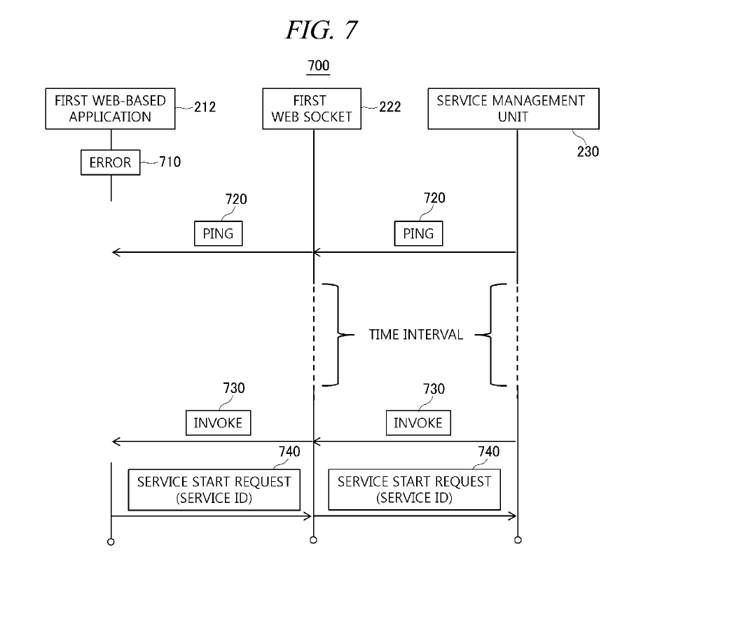

Referring again to FIG. 2, service management unit 230 may be further programmed and/or configured to transmit, to a web-based application, a ping to check whether the web-based application is running or not. As referenced herein, the ping may refer to a computer network administration utility used to test a reachability of a target host on an Internet Protocol (IP) network by measuring in time between a transmission of packets to the target host, and a reception of a response from the target host. Service management unit 230 may invoke the web-based application when a response message to the ping is not transmitted from the web-based application to service management unit 230 as depicted and described with reference to FIG. 7.

FIG. 7 shows an example processing flow 700 of operations by which an erroneous web-based application may be invoked, in accordance with embodiments described herein. The operations of processing flow 700 may be implemented in system configuration 100 including first web-based application 212 executed by web browser engine 210; and a first web socket 222 corresponding to first web-based application 212, service management unit 230 included in device 110 as illustrated in FIG. 1 and FIG. 2. Processing flow 700 may include one or more operations, actions, or functions as illustrated by one or more blocks 710, 720, 730, and/or 740. Although illustrated as discrete blocks, various blocks may be divided into additional blocks, combined into fewer blocks, or eliminated, depending on the desired implementation. Processing may begin at block 710.

Block 710 (Get Error for First Web-Based Application) may refer to first web-based application 212 getting an error caused by, for example, a system down, or disconnection of network 140, etc. Processing may proceed from block 710 to block 720.

Block 720 (Transmit Ping) may refer to service management unit 230 transmitting, to first web-based application 212, a ping to check whether first web-based application 212 is running or not. In some embodiments, the ping may be repeatedly transmitted from service management unit 230 to first web-based application 212 to prevent unintended stop or disconnection of media content. Processing may proceed from block 720 to block 730.

Block 730 (Invoke Erroneous First Web-Based Application) may refer to service management unit 230 invoking first web-based application 212 when service management unit 230 does not receive a response message to the ping for a predetermined time interval. Processing may proceed from block 730 to block 740.

Block 740 (Transmit Service Start Request) may refer to first web-based application 212 transmitting, to service management unit 230 via first web socket 222, a request to start an erroneous first service corresponding to first web-based application 212 to restart the erroneous first service.

Thus, FIG. 7 shows example processing flow 700 of operations by which the erroneous web-based application may be invoked, in accordance with embodiments described herein.

Referring again to FIG. 2, database 240 may be configured to store data, including data input to or output from the components of device 110. Non-limiting examples of such data may include the activated service list which is generated and transmitted by service management unit 230.

Further, by way of example, database 240 may be embodied by at least one of a hard disc drive, a ROM (Read Only Memory), a RAM (Random Access Memory), a flash memory, or a memory card as an internal memory or a detachable memory of device 110.

Thus, FIG. 2 shows example configuration 200 of device 110 on which web-based applications may be hosted and executed, in accordance with embodiments described herein.

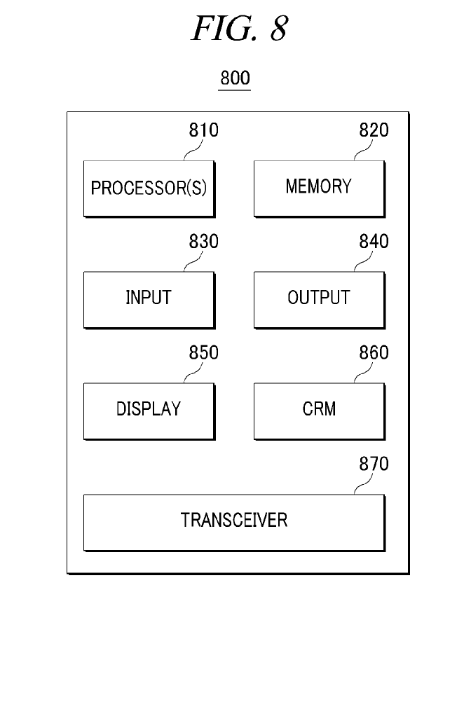

FIG. 8 shows an illustrative computing embodiment, in which any of the processes and sub-processes of hosting and executing web-based applications may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the example system configuration 100 for transactional permissions.

In a very basic configuration, a computing device 800 may typically include, at least, one or more processors 810, a system memory 820, one or more input components 830, one or more output components 840, a display component 850, a computer-readable medium 860, and a transceiver 870.

Processor 810 may refer to, e.g., a microprocessor, a microcontroller, a digital signal processor, or any combination thereof.

Memory 820 may refer to, e.g., a volatile memory, non-volatile memory, or any combination thereof. Memory 820 may store, therein, an operating system, an application, and/or program data. That is, memory 820 may store executable instructions to implement any of the functions or operations described above and, therefore, memory 820 may be regarded as a computer-readable medium.

Input component 830 may refer to a built-in or communicatively coupled keyboard, touch screen, or telecommunication device. Alternatively, input component 830 may include a microphone that is configured, in cooperation with a voice-recognition program that may be stored in memory 830, to receive voice commands from a user of computing device 800. Further, input component 820, if not built-in to computing device 800, may be communicatively coupled thereto via short-range communication protocols including, but not limitation, radio frequency or Bluetooth.

Output component 840 may refer to a component or module, built-in or removable from computing device 800, that is configured to output commands and data to an external device.

Display component 850 may refer to, e.g., a solid state display that may have touch input capabilities. That is, display component 850 may include capabilities that may be shared with or replace those of input component 830.

Computer-readable medium 860 may refer to a separable machine readable medium that is configured to store one or more programs that embody any of the functions or operations described above. That is, computer-readable medium 860, which may be received into or otherwise connected to a drive component of computing device 800, may store executable instructions to implement any of the functions or operations described above. These instructions may be complimentary or otherwise independent of those stored by memory 820.

Transceiver 870 may refer to a network communication link for computing device 800, configured as a wired network or direct-wired connection. Alternatively, transceiver 870 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A device that displays television content on a display, comprising:
a web browser engine configured to host a plurality of web-based applications;
at least one web socket configured to provide each of the plurality of web-based applications with at least one respective TCP connection; and
a service management unit configured to transmit data packets from at least one of the plurality of web-based applications to an external device via the at least one web socket.

2. The device of claim 1, wherein the at least one web socket is assigned to more than one of the plurality of web-based applications.

3. The device of claim 1, wherein a first application of the plurality of web-based applications is configured to transmit a request to start a first service to the service management unit when the first application is executed by the web browser engine.

4. The device of claim 3, wherein the request to start the first service includes a service identifier for the first application.

5. The device of claim 4, wherein the service management unit is further configured to transmit a service approval message to the first application when the first service corresponding to the first service identifier is approved by the service management unit.

6. The device of claim 5, wherein the service management unit is further configured to transmit, to the first application via the at least one web socket, data packets received from the external device after the service management unit transmits the service approval message to the first application.

7. The device of claim 5, wherein the service management unit is further configured to register the first service identifier into an activated service list.

8. The device of claim 7, wherein the service management unit is further configured to transmit the activated service list to a second application when the second application of the plurality of web-based applications transmits a request for the activated service list to the service management unit.

9. The device of claim 8, wherein the service management unit is further configured to transmit, to the first application, data packets received from the second application if the activated service list contains at least the first service identifier.

10. The device of claim 1, wherein a first application of the plurality of web-based applications is configured to transmit a request to convert a protocol to the service management unit when the first application requires a protocol conversion.

11. The device of claim 10, wherein the request to convert the protocol includes protocol information requested by the first application.

12. The device of claim 11, wherein the service management unit is further configured to transmit, to the first application, a notification that a protocol described in the protocol information is supportable by the service management unit.

13. The device of claim 12, wherein first protocol data packets are transmitted from the first application to the service management unit,
wherein the first protocol data packets are converted to second protocol data packets by the service management unit, and
wherein the data packets of the second protocol are transmitted to the external device.

14. The device of claim 5, wherein the service management unit is further configured to transmit, to the first application, a ping to check whether the first application is running or not, and
the service management unit is further configured to invoke the first application when a response message to the ping is not transmitted from the first application to the service management unit.

15. A method, comprising:
executing a plurality of web-based applications;
providing each of the plurality of web-based applications with at least one respective TCP connection; and
transmitting data packets from one of the plurality of web-based applications to an external device via the at least one respective TCP connection.

16. The method of claim 15, wherein each of at least one web sockets is assigned to a respective one of the plurality of web-based applications.

17. The method of claim 15, wherein at least one web socket is assigned to more than one of the plurality of web-based applications.

18. The method of claim 15, further comprising:
registering a service identifier for a first application into an activated service list when the first application from among the plurality of web-based applications is executed; and
transmitting the activated service list to a second application from among the plurality of web-based applications.

19. The method of claim 15, further comprising:
converting first protocol data packets transmitted from a first application from among the plurality of web-based applications into second protocol data packets; and
transmitting the second protocol data packets to the external device.

20. A computer-readable storage medium having thereon computer-executable instructions that, in response to execution, cause a device to perform operations, comprising:
executing a plurality of web-based applications;
providing at least one respective TCP connection to each of the plurality of web-based applications; and
transmitting data packets from at least one of the plurality of web-based applications to an external device via the at least one respective TCP connection.
